(19) United States
(12) Patent Application Publication
(10) Pub. No.: US 2009/0167900 A1
(43) Pub. Date: Jul. 2, 2009

(54) IMAGE PROCESSING METHOD FOR ADJUSTING A SCALE OF A FACE

(75) Inventors: Yin-Pin CHANG, Taipei City (TW); Tai-Chang YANG, Fongshan City (TW); Hong-Long CHOU, Taipei (TW)

Correspondence Address: Workman Nydegger;1000 Eagle Gate Tower, 60 East South Temple, Salt Lake City, UT, 84111, US

(73) Assignee: ALTEK CORPORATION, Hsinchu (TW)

(21) Appl. No.: 12/344,783

(22) Filed: Dec. 29, 2008

(30) Foreign Application Priority Data
Dec. 26, 2007 (TW) 096150364

(51) Int. Cl. H04N 5/262

(52) U.S. Cl. 348/240.99; 348/E05.051

(57) ABSTRACT

An image processing method for adjusting a scale of a face is implemented by a microprocessor of a digital camera. The microprocessor performs a face detection to find the position of a face in the image, and sets a zoom block according to an entire column/row of the position of the face, so as to zoom in/out the scale of the face. When the scale of the face is adjusted, an entire column of pixels are added/deleted with constrain proportions from two sides of the zoom block, for repairing the pixels altered during the zoom in/out of the face so as to remain the whole image undistorted. This method finds the position of the face accurately, and adjusts the pixels at the position of the face, so as to effectively adjust the scale of the face, and avoid disproportion between the face and the body in the image.

### CROSS-REFERENCE TO RELATED APPLICATIONS

This non-provisional application claims priority under 35 U.S.C. §119(a) on Patent Application No(s). 096150364 filed in Taiwan, R.O.C. on Dec. 26, 2007 the entire contents of which are hereby incorporated by reference.

### BACKGROUND OF THE INVENTION

1. Field of Invention

The present invention relates to an image processing method, and more particularly to an image processing method for adjusting a scale of a face in an image.

2. Related Art

Currently, digital cameras are provided with functions such as auto-focusing of the shooting environment, environment brightness detection, and shooting mode switching for shooting a scene. Besides, some cameras are capable of performing digital processing on the shot images, for example, image post-processing like red eye removal and image frame addition. Some of the cameras are even provided with special effect processing functions to make human figures shot in a frame “become slim” or “become fat”, such that the human figures in the image may not look too fat or bony. Actually, when such a digital camera is used to perform special effect processing on an image (for example, to make a human figure look slimmer or fatter), the human face in the image is not zoomed in or out. Since, most of the users are accustomed to placing human figures in a middle portion of an image while shooting, the pixels in the middle portion of the image are shrunk, and those on the left and right sides are expanded, thereby achieving the effect of zooming in/out the face of a human figure.

However, the special effect processing may easily cause image distortion. FIGS. 1A and 1B are schematic views of adjusting a scale of a face in the image in the conventional art. Referring to FIGS. 1A and 1B together, after an image is shot, the central portion of the image is compressed, and thus the face 110 in the central portion “looks slimmer.” However, after the middle portion (i.e., the image between two dashed lines in FIG. 1A) of the image is directly compressed, the barrel 120, shown in FIG. 1B, is apparently distorted, resulting the disproportion of the whole image. Further, not all the faces are located in the central portion of an image. If a face is on either side of the image, instead of looking slimmer after the special effect processing, the face may even look fatter since the pixels on two sides of the image are expanded.

### SUMMARY OF THE INVENTION

Accordingly, the present invention is directed to an image processing method for adjusting a scale of a face. When the a scale of a face in an image is to be zoomed in/out, only the zoom block where the face is located is zoomed in/out, and meanwhile two sides of the zoom block are adjusted to repair the pixels altered by the zoom block, so as to avoid the image distortion.

In order to achieve the above objective, an image processing method for adjusting a scale of a face is provided. The method includes the following steps. First, a face detection is performed on the image to find out a face in the image. Next, a zoom block is set according to the position of the face. Then, a zoom proportion is set, and the zoom block is adjusted with constrain proportions according to the zoom proportion. Thereafter, two sides of the zoom block are adjusted with constrain proportions according to the zoom proportion, so as to maintain a total number of pixels of the image.

In the image processing method for adjusting a scale of a face according to a preferred embodiment of the present invention, the face detection further includes the following steps. First, an edge detection is performed on the image to obtain an edge image. Next, the edge image is compared with multiple face features in a face database, so as to find out a face in the edge image that conforms to the face features in the database. Then, the position of the face is recorded.

In the image processing method for adjusting a scale of a face according to a preferred embodiment of the present invention, the zoom block is an entire row of the position of the face.

In the image processing method for adjusting a scale of a face according to a preferred embodiment of the present invention, the zoom block is an entire column of the position of the face.

In the image processing method for adjusting a scale of a face according to a preferred embodiment of the present invention, a man-machine interface is further provided for a user to set/adjust the zoom proportion. The zoom proportion is a length percentage of the zoom block after adjustment taking up the zoom block before adjustment. In addition, the zoom proportion on the two sides of the zoom block (i.e., the relationship between the two sides of the zoom block before and after adjustment) is represented by the following mathematical expressions:

γ′=γ+γ*X/(γ+δ);

δ′=δ+δ*X/(δ+δ);

where, γ is a total number of columns/rows of the pixels on one side of the zoom block before adjustment, γ′ is a total number of columns/rows of the pixels on one side of the zoom block after adjustment, δ is a total number of columns/rows of the pixels on the other side of the zoom block before adjustment, δ′ is a total number of columns/rows of the pixels on the other side of the zoom block after adjustment, and X is a total number of columns/rows of the adjusted pixels of the zoom block.

In view of the above, the image processing method for adjusting a scale of a face selects a zoom block according to the position of the face, such that only the zoom block is adjusted instead of zooming in/out the whole image when the scale of the face in the image is to be adjusted. Further, after the zoom block is zoomed in/out, the two sides of the zoom block are adjusted with constrain proportions, thereby repairing the image, so as to achieve the purpose of adjusting the scale of the face in the image, and avoiding the image distortion caused by the adjustment.

### BRIEF DESCRIPTION OF THE DRAWINGS

The present invention will become more fully understood from the detailed description given herein below for illustration only, and thus are not limitative of the present invention, and wherein:

FIGS. 1A and 1B are schematic views of adjusting a scale of a face in an image in the conventional art;

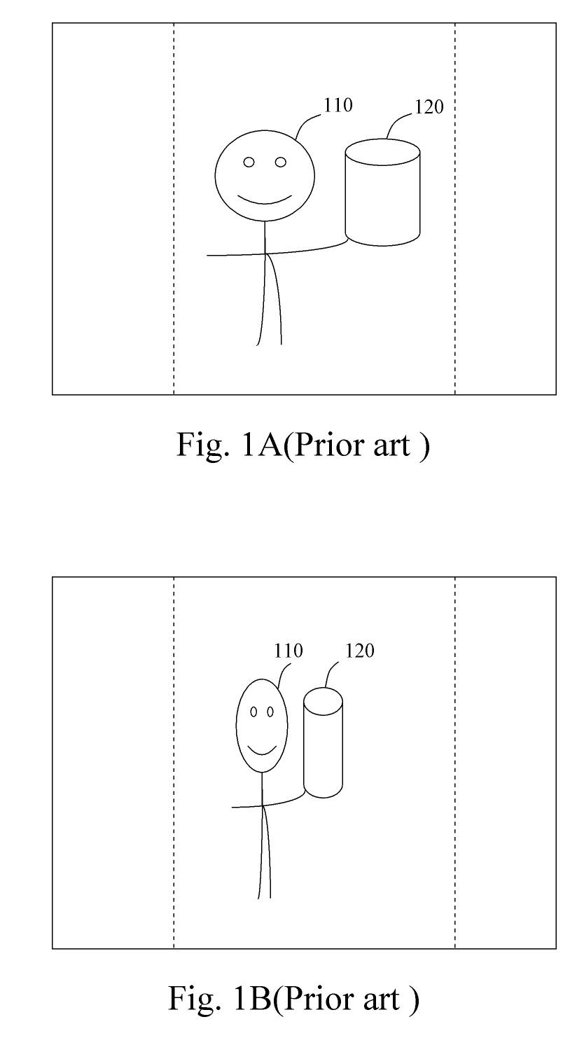

FIG. 2 is a flow chart of an image processing method for adjusting a scale of a face according to the present invention; and

FIGS. 3A and 3B are schematic views of adjusting a scale of a face in an image according to the present invention.

### DETAILED DESCRIPTION OF THE INVENTION

The objective and method of the present invention are described in detail below with preferred embodiments, and the concept of the present invention may also be applied to other scopes. The embodiments below are only used to illustrate the objective and method of the present invention, instead of limiting the scope of the same.

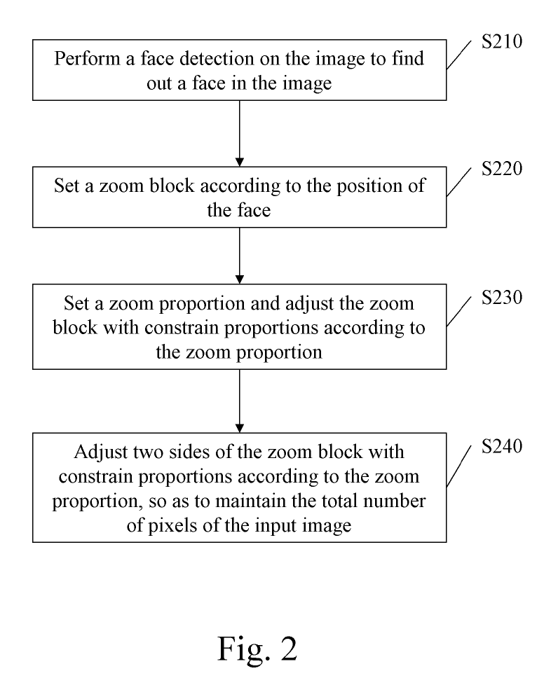

FIG. 2 is a flow chart of an image processing method for adjusting a scale of a face according to the present invention. In this embodiment, after an image is shot with a digital camera, the scale of the face in the image may be adjusted by a microprocessor or a digital signal processing (DSP) chip of the digital camera. The method includes the following steps. First, a face detection is performed on the image to find out at least a face in the image (Step S210). Next, a zoom block is set according to the position of the face (Step S220). Then, a zoom proportion is set, and the zoom block is adjusted with constrain proportions according to the zoom proportion (Step S230). Thereafter, two sides of the zoom block are adjusted with constrain proportions according to the zoom proportion, so as to maintain a total number of pixels of the input image (Step S240).

Thus, in order to precisely adjust the scale of the face in an image, the position of the face must be first found out in the image, i.e., a face detection is performed on the image to find out a face in the image. The face detection includes the following steps. First, an image is input, and an edge detection is performed to obtain an edge image (Step 1). In this embodiment, for example, an edge image is obtained by a Gradient Magnitude method. That is, a matrix of all pixels of the image is multiplied by a horizontal gradient magnitude

$$[ \begin{matrix}- 1 & 0 & 1 \\ - 2 & 0 & 2 \\ - 1 & 0 & 1\end{matrix} ]$$

and a vertical gradient magnitude

$$[ \begin{matrix}- 1 & - 2 & - 1 \\ 0 & 0 & 0 \\ 1 & 2 & 1\end{matrix} ] ,$$

and thus an edge image can be drawn according to the obtained matrix. Other methods like Laplacian, Tengengrad, and 1D Horizontal Filter may also be used to achieve the same purpose, which is not limited herein. After the edge image is obtained (Step 2), the edge image is compared with multiple face features in a face database, so as to find out the face in the image, and the information about the position of the face is recorded (Step 3).

After the face is found in the image, the scale of the face is adjusted. However, to avoid the cases that the human figure shot in the image looks “top-heavy” or “bottom-heavy” (i.e., the proportions of body of the human figure is abnormal), in this embodiment, a zoom block is selected, and the zoom block is adjusted with constrain proportions, so as to avoid body disproportion caused by the adjustment of only the face. Entire columns or rows of the position of the face in the image are selected as a zoom block according to the laying of the human figure in the image, i.e., whether the human figure is laid vertically (perpendicular to the horizon line) or transversely (parallel to the horizon line). If the human figure in the image is laid vertically, the entire columns of the position of the face are selected as the zoom block. On the contrary, if the image is placed transversely, the entire rows of the position of the face are selected as the zoom block.

A user may set the zoom proportion of the zoom block through a man-machine interface. In some embodiments, the man-machine interface is, for example, physical keys on the digital camera or virtual keys on the screen (touch screen) of the digital camera. After a microprocessor (or DSP chip) of the digital camera receives a zoom proportion input by the user, the zoom block is adjusted according to the zoom proportion. The zoom proportion is a length percentage of the zoom block after adjustment taking up the zoom block before adjustment. The total number of columns/rows of the pixels requiring for adjustment in the zoom block is represented by the following mathematical expression: the total number of columns/rows of the adjusted pixels of the zoom block=the total number of columns/rows of the pixels of the zoom block*(1−zoom proportion).

It must be noted that if the human figure in the frame stands upright, the entire columns of the zoom block are adjusted, i.e., the entire columns of pixels are added/deleted to make the face in the frame become fatter/slimmer. On the contrary, if the human figure in the frame is laid transversely, the entire rows of the zoom block are adjusted, i.e., the entire rows of pixels are added/deleted to make the face in the frame become fatter/slimmer.

In an embodiment, the human figure in the frame stands upright. If the width of the zoom block is set to be 100 pixels, and a zoom proportion set by the user is 80%, when the zoom block is adjusted, the total number of columns of the pixels requiring for adjustment in the zoom block is first calculated. After a result of calculation of the microprocessor of the digital camera is that 20 columns of pixels need to be deleted from the zoom block with constrain proportions, the extra pixels are deleted from left to right at equal intervals (i.e. an entire column of pixels is deleted every other five pixels). Afterwards, the remaining 80 columns of pixels are integrated into a zoom block after adjustment. The width of the zoom block after adjustment is 80 pixels, and thus the face in the image looks slimmer. Since the body of the human figure is also circled to be the zoom block, after the scale of the face is adjusted, the human figure in the image is not unnatural. Accordingly, if the user intends to make the face in the image look plump, the zoom proportion may be set to be 120%, and the width of the zoom block after adjustment turns to be 120 pixels.

In order to maintain the original size of the image to make the image look more natural, after the zoom block is zoomed out (compressed inwardly), the image on the two sides of the zoom block needs to be zoomed in with constrain proportions, so as to repair the lacked pixels after the adjustment (inward compression) of the zoom block. Accordingly, if the zoom block is zoomed out by 20 columns of pixels, the two sides of the zoom block must be added with 20 columns of pixels. The zoom proportion on the two sides of the zoom block is represented by the following mathematical expressions:

γ′=γ+γ*X/(γ+δ;

δ′=δ+δ*X/(γ+δ;

where γ is a total number of columns/rows of the pixels on one side of the zoom block before adjustment, γ′ is a total number of columns/rows of the pixels on one side of the zoom block after adjustment, δ is a total number of columns/rows of the pixels on the other side of the zoom block before adjustment, δ′ is a total number of columns/rows of the pixels on the other side of the zoom block after adjustment, and X is a total number of columns/rows of the adjusted pixels of the zoom block. Accordingly, if the pixel width on the left side of the zoom block is 200 pixels, and the pixel width on the right side of the zoom block is 300 pixels, 8 columns of pixels are added on the left side of the zoom block, and 12 columns of pixels are added on the right side of the zoom block. In detail, a column of pixels are added every other 25 columns from left to right on the left side of the zoom block (the value of each pixel in the added column is a mean value of its adjacent pixels), and a column of pixels are added every other 25 columns from left to right on the right side of the zoom block. As such, the image will maintain the original size and look more natural.

In another embodiment, the human figure in the frame is transversely laid. In order to adjust the scale of the face in the frame, a process similar to the above adjustment of an upright human figure in a frame must be performed. First, a zoom proportion is set by the user. Then, the position of the face is found in the frame. The entire rows of the position of the face are set to be a zoom block. Afterwards, the entire rows of pixels in the zoom block are adjusted with constrain proportions. Finally, two sides (the upper and lower sides thereof) of the zoom block are adjusted, so as to make the image maintain its original size. The process has already been illustrated in detail in the above embodiments, and will not be repeated herein again.

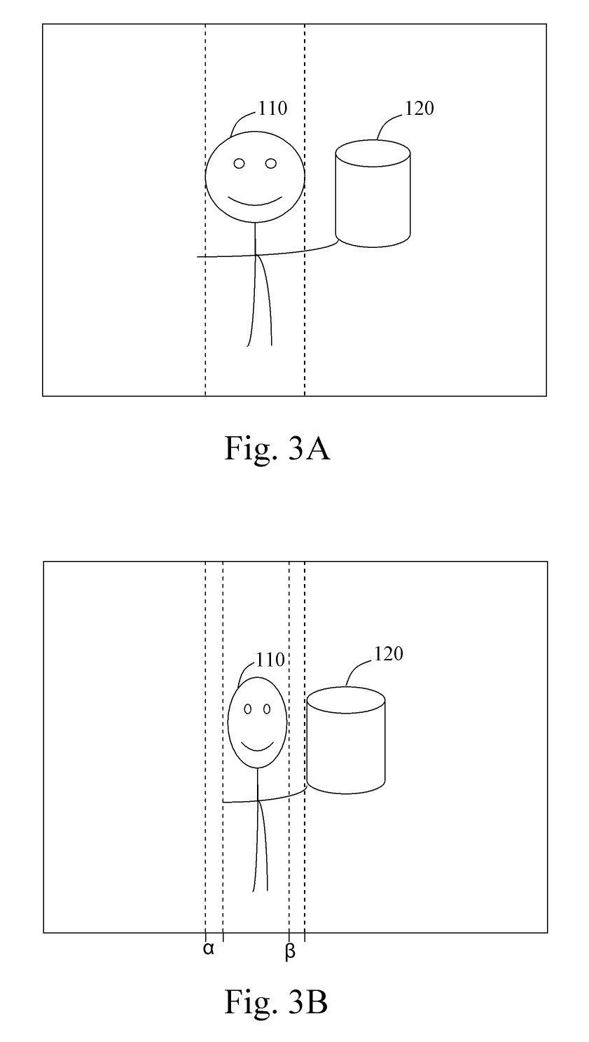

In order to clarify this embodiment, the image processing method for adjusting a scale of a face is illustrated below with the accompanying drawings. FIGS. 3A and 3B are schematic views of adjusting a scale of a face in an image according to the present invention. Referring to FIGS. 3A and 3B together, after an image is shot by the user (as shown in FIG. 3A), the special effect processing will be performed on the face 110 in the image to make the face “look slimmer.” First, a zoom proportion is set to be 60% by the user through a man-machine interface (for example, physical keys aside the screen of the camera) on the digital camera. Next, a face detection is performed by a microprocessor of the digital camera (hereinafter, referred to as the microprocessor) to find out the face 110, and a zoom block is disposed according to the position of the face 110 (i.e., the block enclosed by two dashed lines in FIG. 3A). Afterwards, the microprocessor calculates the width of the zoom block to be zoomed out based on the zoom proportion, and accordingly zooms out the zoom block. Meanwhile, the pixels are compensated on two sides of the zoom block. After the result of calculation of the microprocessor is that α columns of pixels must be added on the left side of the zoom block, and β columns of pixels must be added on the right side of the zoom block, the pixels are added in proportion (for example, the pixels are compensated on the two sides of the zoom block in the above manner, i.e., an entire column of pixels is added at equal intervals). Thus, the purpose of image compensation is achieved as shown in FIG. 3B. Seen from FIG. 3B, the image processing method for adjusting a scale of a face provided by the present invention ensures that the face image is located in the zoom block, and the barrel 120 held by the human figure may not be distorted due to the adjustment of the face.

In view of the above, the present invention determines the position of a face through the face detection, and sets entire columns/rows of the position of the face to be a block to be adjusted. Therefore, the block is adjusted to adjust the whole proportion of the human figure, so as to make the body be in harmony with the face. Further, after the zoom block where the face is located is adjusted, the two sides of the zoom block are adjusted with constrain proportions, such that the pixels altered due to the adjustment of the face image (the entire columns of pixels added/deleted) are repaired, thereby avoiding the image distortion caused by the adjustment of the scale of the face.

What is claimed is:

1. An image processing method for adjusting a scale of a face, adapted to adjusting the scale of the face in a shot image by a microprocessor or a digital signal processing (DSP) chip of a digital camera, the image processing method comprising:
performing a face detection on the image to find out at least a face in the image;
setting a zoom block according to the position of the face;
setting a zoom proportion and adjusting the zoom block with constrain proportions according to the zoom proportion; and
adjusting two sides of the zoom block with constrain proportions according to the zoom proportion, so as to maintain a total number of pixels of the image.

2. The image processing method for adjusting a scale of a face as claimed in claim 1, wherein the face detection comprises:
performing an edge detection on the image to obtain an edge image;
comparing the edge image with multiple face features in a face database, so as to find out the face in the image; and
recording the position of the face.

3. The image processing method for adjusting a scale of a face as claimed in claim 1, wherein the zoom block is an entire column of the position of the face in the image.

4. The image processing method for adjusting a scale of a face as claimed in claim 1, wherein the zoom block is an entire row of the position of the face in the image.

5. The image processing method for adjusting a scale of a face as claimed in claim 1, further comprising providing a man-machine interface for a user to set the zoom proportion.

6. The image processing method for adjusting a scale of a face as claimed in claim 1, wherein the zoom proportion is a length percentage of the zoom block after adjustment taking up the zoom block before adjustment.

7. The image processing method for adjusting a scale of a face as claimed in claim 1, wherein a process of adjusting the zoom block with constrain proportions further comprises:
calculating the zoom block and several columns of pixels requiring for adjustment on the two sides of the zoom block according to the zoom proportion;
inserting/deleting the entire columns of pixels at equal intervals in the zoom block; and
deleting/inserting the entire columns of pixels at equal intervals on the two sides of the zoom block.

8. The image processing method for adjusting a scale of a face as claimed in claim 1, wherein the process of adjusting the zoom block with constrain proportions further comprises:
calculating the zoom block and several columns of pixels requiring for adjustment on the two sides of the zoom block according to the zoom proportion;
inserting/deleting the entire rows of pixels at equal intervals in the zoom block; and
deleting/inserting the entire rows of pixels at equal intervals on the two sides of the zoom block.

9. The image processing method for adjusting a scale of a face as claimed in claim 1, wherein the zoom proportion on the two sides of the zoom block is represented by the following mathematical expressions:
γ′=γ+γ*X/(γ+δ;
δ′+δ+δ*X/(γ+δ); where
γ is a total number of columns/rows of the pixels on one side of the zoom block before adjustment;
γ′ is a total number of columns/rows of the pixels on one side of the zoom block after adjustment;
δ is a total number of columns/rows of the pixels on the other side of the zoom block before adjustment;
δ′ is a total number of columns/rows of the pixels on the other side of the zoom block after adjustment; and
X is a total number of columns/rows of the adjusted pixels of the zoom block.
